(19) United States
(12) Patent Application Publication
(10) Pub. No.: US 2025/0350961 A1
(43) Pub. Date: Nov. 13, 2025

(54) System and Method of Adapting Telecommunication Network Based on Subscriber-centric Voice Call Metric

(71) Applicant: T-Mobile Innovations LLC, Overland Park, KS (US)

(72) Inventors: Manjith BAHULEYAN, Bothell, WA (US); Sanjay Dashrathsinh BRAHMBHATT, Snoqualmie, WA (US); Rodney D. HOON, Seattle, WA (US); Evstratios J. KOUTROULIS, Seattle, WA (US); Zain Us Salekin MOHAMMED, Bellevue, WA (US)

(21) Appl. No.: 18/658,624

(22) Filed: May 8, 2024

(51) Int. Cl. H04W 24/02; H04W 8/22; H04W 24/08

(52) U.S. Cl. CPC H04W 24/02; H04W 8/22; H04W 24/08

(57) ABSTRACT

A method of adapting a communication network to improve communication quality. The method comprises, for each of a plurality of subscribers, analyzing call detail records (CDRs) of the subscriber by an application executing on a computer system to identify negative voice call events; for each negative voice call event, associating a location of a subscriber communication device at the time of the negative voice call event by the application to the negative voice call event; for each of the plurality of subscribers, determining a subscriber-centric voice call metric for the subscriber by the application based on a count of negative voice call events of the subscriber for each of a plurality of one hour intervals; for each subscriber, determining an average subscriber-centric voice call metric by the application by averaging the subscriber-centric metric values determined for each of the plurality of one hour intervals; and taking action accordingly.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Telecommunication network operators generate performance metrics on communications service provided to subscribers. The network operators may average these performance metrics across its subscribers to evaluate an aggregate performance of its network and to identify regions or even individual cell sites that do not provide a desired level of communication service quality. This analysis may be used to identify areas where new cell sites may be deployed to provide better coverage and/or higher communication service quality. This analysis may be used to identify cell sites that may desirably be upgraded.

### SUMMARY

In an embodiment, a method of adapting a communication network to improve communication quality based on voice call metrics determined on a subscriber-by-subscriber basis is disclosed. The method comprises accessing subscriber voice call information from a first data store by an application executing on a computer system, where the call information is associated with a first period of time; accessing subscriber churn information from a second data store by the application, where the subscriber churn information identifies subscribers of a telecommunication company who discontinue their telecommunication subscription service; and training a subscriber churn machine learning (ML) model based on the subscriber voice call information accessed from the first data store and based on the subscriber churn information accessed from the second data store by the application, wherein the subscriber churn ML model is configured to determine a risk of subscriber churn based on a subscriber-centric voice call metric. The method further comprises, for each of a plurality of subscribers of the telecommunication company, determining the subscriber-centric voice call metric for the subscriber by the application, wherein the subscriber-centric voice call metric is determined over a second period of time based on a count of dropped calls experienced by the subscriber, a count of blocked calls experienced by the subscriber, a count of garbled calls experienced by the subscriber, and a count of failed attempts to call a voice mail account of the subscriber, wherein the second period of time starts after the first period of time ends and wherein the second period of time is shorter than the first period of time. The method further comprises, for each of the plurality of subscribers, determining a risk of the subscriber churning by the application based on processing the subscriber-centric voice call metric of the subscriber determined over the second period of time using the subscriber churn ML model; identifying a first subscriber associated with a risk of subscriber churn above a threshold; and taking action to improve the voice call service of the first subscriber.

In another embodiment, a method of adapting a communication network to improve communication quality based on voice call metrics determined on a subscriber-by-subscriber basis. The method comprises, for each of a plurality of subscribers of a telecommunication company, analyzing call detail records (CDRs) of the subscriber by an application executing on a computer system to identify negative voice call events; and, for each negative voice call event, associating a location of a subscriber communication device at the time of the negative voice call event by the application to the negative voice call event. The method further comprises, and for each of the plurality of subscribers, determining a subscriber-centric voice call metric for the subscriber by the application based on a count of negative voice call events of the subscriber for each of a plurality of one hour intervals. The method further comprises, for each of the plurality of subscribers, determining an average subscriber-centric voice call metric by the application by averaging the subscriber-centric metric values determined for each of the plurality of one hour intervals; and for a subscriber associated with an average subscriber-centric voice call metric that is below a predefined threshold, taking action to improve the voice call service of the subscriber based on a location where the subscriber negative voice call experiences occurred.

In yet another embodiment, a method of adapting a communication network to improve communication quality based on voice call metrics determined on a subscriber-by-subscriber basis is disclosed. The method comprises, for each of a plurality of subscribers of a telecommunication company, determining a subscriber-centric voice call metric for the subscriber by an application executing on a computer system by analyzing call detail records (CDRs) of the subscriber, wherein the subscriber-centric voice call metric is determined based on a count of negative voice call experiences of the subscriber for each of a plurality of one hour intervals; and, for each of the plurality of subscribers, determining an average subscriber-centric voice call metric by the application by averaging the subscriber-centric metric determined for each of the plurality of one hour intervals. The method further comprises, for a first subscriber associated with an average subscriber-centric voice call metric that is below a predefined threshold, installing a different preferred roaming list (PRL) on a communication device of the first subscriber; for a second subscriber associated with an average subscriber-centric voice call metric that is below the predefined threshold, sending a notification to the second subscriber to authorize a software update on a communication device of the second subscriber to reduce negative voice call experiences; and for a third subscriber associated with an average subscriber-centric voice call metric that is below the predefined threshold, sending a notification to the third subscriber recommending upgrading a communication device of the third subscriber to reduce negative voice call experiences.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2A and FIG. 2B are a flow chart of a method according to an embodiment of the disclosure.

FIG. 3 is a flow chart of another method according to an embodiment of the disclosure.

FIG. 4 is a flow chart of yet another method according to an embodiment of the disclosure.

FIG. 5A and FIG. 5B are a block diagram of a communication network according to an embodiment of the disclosure.

FIG. 6 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Telecommunication network operators and/or communication service providers typically monitor and evaluate the quality of communication service they deliver to subscribers in an averaged way. Such averaging smooths out and ignores outliers of poor network performance that may lead to subscribers terminating their communication service with their initial communication service provider and switching service to a different service provider. This loss of subscribers is commonly referred to as subscriber churn or simply “churn.” Once lost, subscribers rarely return to the initial communication service provider and hence this is a long-term economic impact on the communication service provider. Even a low rate of subscriber churn can be harmful to a service provider's economic position. Thus, missing outliers of poor network performance that results in even a low rate of subscriber churn is desirably avoided.

The present disclosure teaches methods and systems for detecting and avoiding poor communication service for even small numbers of service subscribers. In an embodiment, an application executing on a computer system analyzes call detail records (CDRs) accessed from a data store to identify communication events deemed contrary to subscriber satisfaction. Without limitation, these negative events may include (1) wireless voice calls that are dropped mid-call; (2) wireless voice calls that are garbled; (3) attempts to initiate wireless voice calls that are blocked; and (4) attempts to call voice mail that fail. The application creates an event artifact for each of these negative events and may enrich information related to the event by associating additional information to the event such as a cell site identity related to the negative event. The application may search a separate data store to obtain location subscriber records (LSRs) indicating a location of a communication device (user equipment or “UE”) associated with the subscriber and attach the location of the UE to the event artifact. For each subscriber, the application builds a count of all the negative events experienced by the subscriber during a first period of time. This is different from the determination of network-centric metrics where different negative events are tracked in separate different metrics. The accumulation of counts of different negative events under one count can make the subscriber-centric evaluation of communication experience more efficient. The counts of negative events can be stored in a data store for efficient processing. The application then determines a rate of negative events for the subscribers over a second, longer period of time. For example, the negative events for each subscriber may be summed for every hour over a period of seven days. The average count per hour may be determined. If the rate of negative events for a subscriber exceeds a predetermined threshold, action can be taken to mitigate the negative events experienced by the subscriber.

It will be appreciated that this approach varies from conventional metrics and network mitigations. Conventional metrics do not focus on individual subscribers but instead typically determine an average over a plurality of subscribers, for example, an average number of blocked calls or an average number of dropped calls associated with a given cell site does not focus on an individual subscriber but a large number of subscribers who use the given cell site over time. Conventional metrics may not identify a problem experienced by individual subscribers which may be outliers for some reason. The subscriber centric metrics described herein support identification of such subscriber-centric problems. In turn, the identification of problems peculiar to specific subscribers can allow the service provider to remedy to reach out to the subscribers and address the problems before the subscriber becomes irritated and churns.

One action the service provider may take in this case is to send a notification to a subscriber that points out that the communication service quality degradation that the subscriber is experiencing is due to an out-of-date software version on the UE of the subscriber. Some subscribers resist updating their UEs with new software versions, and this can sometimes result in poor communication service for down rev UEs. Another action the service provider may take is to send a notification to a subscriber that points out that the UE of the subscriber is very old and this may be causing the subscriber to experience poor communication service, perhaps even offering a special discount to the specific subscriber to address their particular case. Another action the service provider may take is to push a different preferred roaming list (PRL) to the UE of the subscriber. When it is determined that a subscriber has voice call problems primarily while attached to a particular cell site (and not while attached to other different cell sites), this could trigger opening an incident report (e.g., a trouble ticket) in an incident reporting system, and in turn maintenance personnel of the telecommunication network operator may troubleshoot and fix a problem of the cell site that is causing the problems for the subscriber. Likewise, if a plurality of subscribers are having voice call problems primarily while attached to a particular cell site, again, this system can detect that and automatically open an incident report that can result in a degradation of the cell cite being identified and corrected.

In an embodiment, a machine learning (ML) application analyzes historical CDRs, historical LSRs, and churn history to train a churn model. The churn model can then be used to determine a churn risk based on the subscriber-centric metric described above and the churn model. If the risk of churning is above a threshold value, the service provider can take appropriate action. The appropriate action may comprise one or more of the actions described above but also possibly initiating a more direct interaction with the subscriber, for example having a customer care representative call the subscriber, acknowledge the subscribers past service quality problem, and explicitly notify the subscriber that actions have been taken to improve service quality of the subscriber.

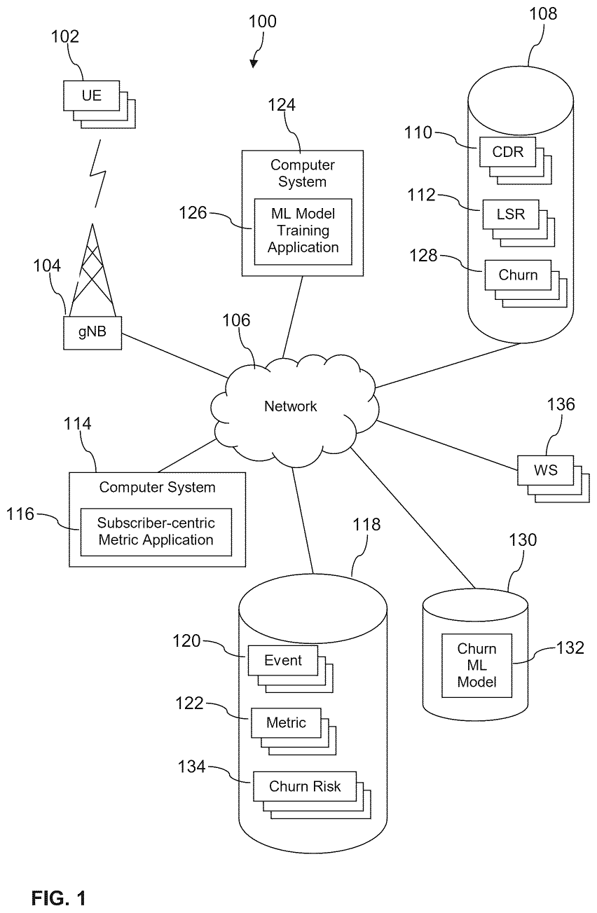

Turning now to FIG. 1, a system 100 is described. In an embodiment, system 100 comprises a first user equipment (UE) 102, a cell site 104, and a telecommunication network 106. The first UE 102 may be a mobile phone, a personal digital assistant (PDA), a smart phone, a wearable computer, a headset computer, a laptop computer, a notebook computer, or a tablet computer. The cell site 104 provides a wireless communication link to the UE 102 according to a 6G, a 5G, a long-term evolution (LTE), a code division multiple access (CDMA), or a global system for mobile communication (GSM) telecommunication protocol. It is understood that the system 100 may comprise any number of UEs 102 and any number of cell sites 104. In an embodiment, a wireless communication service provider may provide wireless communication services to tens of millions of different UEs 102 and may operate a radio access network (RAN) comprising tens of thousands and even hundreds of thousands of cell sites 104. The network 106 may comprise one or more public networks, one or more private networks, or a combination thereof.

The first UE 102 may communicate with a second UE 102 that itself is communicatively linked via the cell site 104 or via a different cell site to the network 106. The two UEs 102 may engage in a voice call. The second UE 102 may be a different kind of UE than the first UE 102. The second UE 102 may receive a wireless link from the cell site 104 or a different cell site, where its wireless link is provided in accordance with the same telecommunication protocol as that of the wireless link from the first UE 102 to the cell site 104. The second UE 102 may receive a wireless link from the cell site 104 or a different cell site, where its wireless link is provided in accordance with a different telecommunication protocol from the telecommunication protocol of the wireless link from the first UE 102 to the cell site 104. The first UE 102 and the second UE 102 may have wireless communication service subscriptions with the same service provider or with different service providers.

The service provider that provides wireless communication subscription service to the first UE 102 may generate call detail records (CDRs) 110 and location subscriber records (LSRs) 112 that are stored in a first data store 108. The CDRs 110 may provide information captured about voice calls or data calls of the UE 102. The CDRs 110 may include one or more of call origination time, call termination time, information about the call route (e.g., the network path the call content follows), an identity of the calling UE 102, a device type of the calling UE 102, a make and model of the calling UE 102, an identity of the called UE 102, and information about the call state. Call states may provide indications of call blockage (can't originate a call due to overloaded cell site 104), call drop (failed handoff and/or overloaded cell site 104), garbled voice content, and failure to reach voice mail. In an embodiment, the CDRs 110 may be enriched CDRs that have had data external to basic CDRs attached to form the enriched CDRs. For example, device details about the UE 102 may be attached to the basic CDRs to make the CDRs 110. For example, information about the cell site 104 may be attached to the basic CDRs to make the CDRs 110. For example, information about the location of the UE 102 may be attached to the basic CDRs to make the CDRs 110. The location of the UE 102 may be obtained from location subscriber records (LSR) 112.

The system 100 further comprises a first computer system 114 that executes a subscriber-centric metric application 116 that determines a subscriber-centric metric for each of a plurality of subscribers of a telecommunication service provider. In an embodiment, the subscriber-centric metric is determined for each separate service line associated with a subscription account. Thus, for example, a single subscription plan (e.g., a family subscription plan) that has multiple individual lines associated with the single subscription may be associated with separate subscriber-centric metrics for each line of the single subscription. The subscriber-centric metric application 116 analyzes the CDRs 110 associated with the plurality of subscribers, and for each subscriber and/or for each line of each subscriber determines a subscriber-centric metric. In an embodiment, the subscriber-centric metric application 116 determines the metric for each of a plurality of time periods and determines an average subscriber-centric metric application 116 for a longer time period. For example, the subscriber-centric metric application 116 may determine the metric for each hourly period of service over a week's time (e.g., 168 separate hourly metrics) and determine an average value for the subscriber-centric metric for that week. In an immediately following week, the subscriber-centric metric application 116 may repeat this calculation of hourly subscriber-centric metrics and average metric for each subscriber and/or each line of each subscriber the subsequent week, and so on.

In an embodiment, the subscriber-centric metric application 116 analyzes CDRs 110 (which in an embodiment may be enhanced CDRs) to identify negative voice call events for each subscriber and/or for each service line of each subscriber. Negative voice call events are instances where something about a voice call exhibits low communication quality of fails. Negative voice call events can include (1) blocked calls (failed attempts to originate a voice call by the UE 102), (2) dropped calls (an established voice call is terminated by the network rather than by the originating or terminating UE 102), (3) garbled voice during a voice call, and (4) failure to reach voice mail. It is understood that other negative voice call events may also be identified by the subscriber-centric metric application 116 in addition to these enumerated negative call events. The subscriber-centric metric application 116 then stores these negative call events 120 in a second data store 118. The subscriber-centric metric application 116 analyzes the negative call events 120 to develop the subscriber-centric metrics 122. The subscriber-centric metrics 122 associated with a subscriber and/or each of a plurality of service lines associated with each subscriber may be determined by the subscriber-centric metric application 116 as the total count of all negative call events 120 associated with the associated subscriber and/or service line over a plurality of periods of time. The periods of time may be fifteen minute periods of time, thirty minute periods of time, one hour periods of time, three hour periods of time, six hour periods of time, twelve hour periods of time, or twenty-four hour periods of time. Additionally, the subscriber-centric metric application 116 may determine an average number of negative events per periodic interval of time over a longer period of time for each subscriber and/or for each service line associated with each subscriber, for example over a period of a week, over a period of two weeks, over a period of a month, over a period of two months, over a period of six months, or over some other duration of time.

The subscriber-centric metrics 122 can provide value to a telecommunication service provider. For example, when a call center employee receives a customer care call from a subscriber, the call center employee can use a workstation 136 to look at the service history of the subject subscriber, including current subscriber-centric metrics associated with the service line(s) of the subscriber. The call center employee may be able to suggest actions to take, with the subscriber's permission, that may improve the quality of the subscriber's service. For example, the call center employee may indicate to the subscriber that the degraded service quality may be due to the subscriber's continued use of an old or obsolete mobile phone. The call center employee may recommend that the subscriber upgrade their mobile phone to a more recent model and may offer a discount to the customer, whereby to increase the quality of the customer's communication service and to reduce the likelihood that this subscriber may churn (e.g., discontinue subscription with his or her current wireless communication service provider and switch service to a different service provider). The call center employee may suggest that the subscriber agree to the installation of a software revision on his or her mobile phone. Some subscribers may sometimes refuse to accept software updates on their phones from fear that the update may change the customary layout of features on the user interface of the phone or may change other functional aspects of their phone. In this circumstance, as the subscriber continues to refuse software updates offered for his or her device, the device may become fragile and subject to increased rates of negative call events.

The system 100 may further comprise a second computer system 124 that executes a machine learning (ML) model training application 126. The ML model training application 126 processes historical CDRs 110 and historical LSRs 112. Historical CDRs and/or historical LSRs may be from periods of time that precede a current period of time—for example where the average subscriber-centric metrics are determined over a most recent month of hourly metrics, the historical CDRs 110 and/or historical LSRs 112 may be from before the most recent month. The ML model training application 126 also processes churn records 128 stored in the second data store 118. The ML model training application 126 generates a churn ML model 132 that is able to determine the likelihood that given subscriber will churn based on current CDRs 110 and/or current LSRs 112 associated with that subscriber. The ML model training application 126 can adapt the churn ML model 132 over time as new CDRs 110, new LSRs 112, and new churn records 128 are stored in the first data store 108.

The subscriber-centric metric application 116 can execute the churn ML model 132 based on current subscriber-centric metrics 122 to predict a churn risk 134 for each of the subscribers and/or each service line of each of the subscribers. The churn risk 134 can be recalculated periodically as new subscriber-centric metrics 122 are generated. The subscriber-centric metric application 116 may compare churn risk 134 values to a predefined threshold and create a job for employees of a telecommunication service provider to handle to reach-out to the associated subscriber.

In an embodiment, a customer care specialist may be assigned a task to contact a subscriber associated with a high churn risk 134, whereby to sympathize with the subscriber and explore possible solutions for the subscriber that can reduce the likelihood of that subscriber churning. For example, the customer care specialist may call the subscriber, describe the degraded voice communication service the subscriber has experienced, ask if the subscriber has noted the degraded service. The customer care specialist may suggest one or more actions that can be taken to improve the subscriber's communication service, for example approving a software upgrade of the UE 102, for example upgrading the UE 102, for example installing a new PRL on the UE 102. For example, the customer care specialist may recommend the subscriber install a small cell site (e.g., a so-called “picocell”) within a residence of the subscriber or in a workplace of the subscriber where the customer experiences degraded voice service.

For example, the customer care specialist may notify the subscriber that some of their wireless communication service is provided in a well-known coverage hole and the service provider has plans to address this problem by installing one or more new cell sites in the near future. For example, the customer care specialist may notify the subscriber that some of their wireless communication service is provided in a well-known coverage hole, express regret for that poor coverage, suggest the subscriber avoid that particular location where the well-known coverage hole occurs, and indicate that a landowner in the location is adamantly opposed to installing a cell site in that location. It may be that a subscriber that would otherwise churn under one of these scenarios would NOT churn when they have been approached with a solution and/or an explanation of the degraded service the customer has experienced. The development of the subscriber-centric metrics described herein promotes this kind of focus on identifying a problem experienced by individual subscribers versus only looking at averaged values. This can improve the experience of the subscriber.

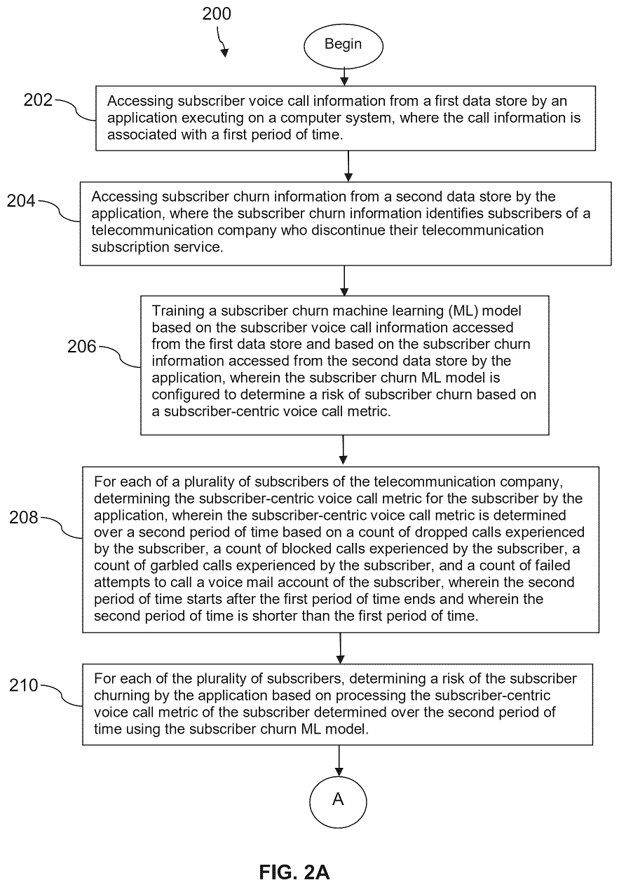

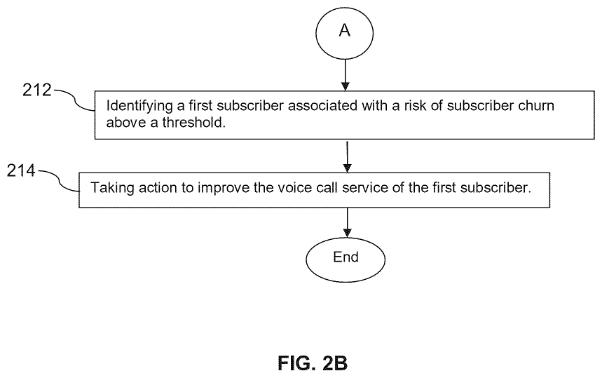

Turning now to FIG. 2A and FIG. 2B, a method 200 is described. In an embodiment, the method 200 is a method of adapting a communication network to improve communication quality based on voice call metrics determined on a subscriber-by-subscriber basis. In an embodiment, the communication network comprises a long-term evolution (LTE) communication network. In an embodiment, the communication network comprises a 5G communication network.

At block 202, the method 200 comprises accessing subscriber voice call information from a first data store by an application executing on a computer system, where the call information is associated with a first period of time. In an embodiment, the subscriber voice call information comprises an identity of a preferred roaming list (PRL) installed on a wireless communication device of the subscriber. In an embodiment, the subscriber voice call information comprises a device type of a communication device of the subscriber, for example a device type of the UE 102. In an embodiment, the subscriber voice call information comprises a make and model of a communication device of the subscriber, for example a make and model of the UE 102. At block 204, the method 200 comprises accessing subscriber churn information from a second data store by the application, where the subscriber churn information identifies subscribers of a telecommunication company who discontinue their telecommunication subscription service.

At block 206, the method 200 comprises training a subscriber churn machine learning (ML) model based on the subscriber voice call information accessed from the first data store and based on the subscriber churn information accessed from the second data store by the application, wherein the subscriber churn ML model is configured to determine a risk of subscriber churn based on a subscriber-centric voice call metric.

At block 208, the method 200 comprises, for each of a plurality of subscribers of the telecommunication company, determining the subscriber-centric voice call metric for the subscriber by the application, wherein the subscriber-centric voice call metric is determined over a second period of time based on a count of dropped calls experienced by the subscriber, a count of blocked calls experienced by the subscriber, a count of garbled calls experienced by the subscriber, and a count of failed attempts to call a voice mail account of the subscriber, wherein the second period of time starts after the first period of time ends and wherein the second period of time is shorter than the first period of time. At block 210, the method 200 comprises, for each of the plurality of subscribers, determining a risk of the subscriber churning by the application based on processing the subscriber-centric voice call metric of the subscriber determined over the second period of time using the subscriber churn ML model.

At block 212, the method 200 comprises identifying a first subscriber associated with a risk of subscriber churn above a threshold. At block 214, the method 200 comprises taking action to improve the voice call service of the first subscriber. In an embodiment, taking action comprises installing a new PRL on a wireless communication device of the first subscriber. In an embodiment, taking action comprises recommending that the first subscriber purchase a different wireless communication device.

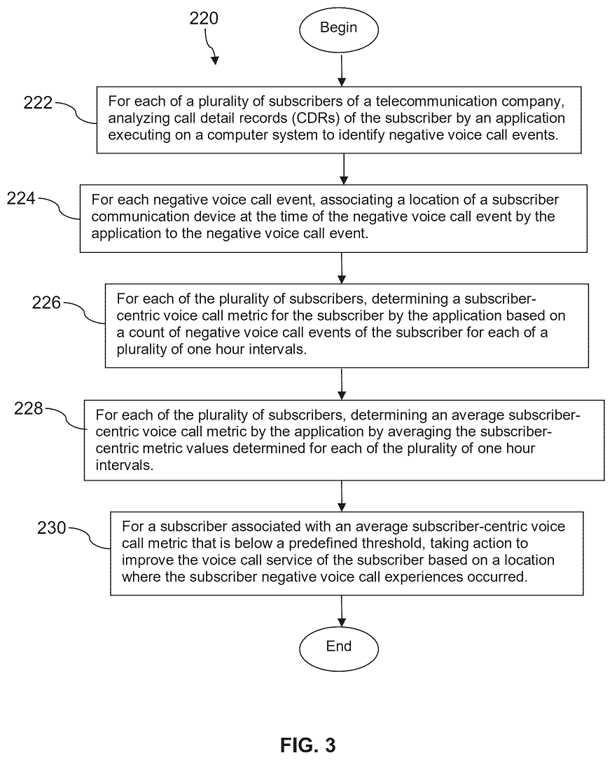

Turning now to FIG. 3, a method 220 is described. In an embodiment, the method 220 is a method of adapting a communication network to improve communication quality based on voice call metrics determined on a subscriber-by-subscriber basis. In an embodiment, the communication network is one of a 6G, a 5G, or a long-term evolution communication network. At block 222, the method 220 comprises, for each of a plurality of subscribers of a telecommunication company, analyzing call detail records (CDRs) of the subscriber by an application executing on a computer system to identify negative voice call events. At block 224, the method 220 comprises for each negative voice call event, associating a location of a subscriber communication device at the time of the negative voice call event by the application to the negative voice call event. In an embodiment, each subscriber communication device is a device selected from the group consisting of a mobile phone, a smart phone, a personal digital assistant (PDA), a wearable computer, a headset computer, a laptop computer, a notebook computer, and a tablet computer.

At block 226, the method 220 comprises, for each of the plurality of subscribers, determining a subscriber-centric voice call metric for the subscriber by the application based on a count of negative voice call events of the subscriber for each of a plurality of one hour intervals. At block 228, the method 220 comprises, for each of the plurality of subscribers, determining an average subscriber-centric voice call metric by the application by averaging the subscriber-centric metric values determined for each of the plurality of one hour intervals. In an embodiment, the average customer-centric voice call metric for each customer is determined over at least a one-week period of time and less than a two-week period of time. In an embodiment, the average customer-centric voice call metric for each customer is determined over at least a two-week period of time and less than a three-month period of time. At block 230, the method 220 comprises, for a subscriber associated with an average subscriber-centric voice call metric that is below a predefined threshold, taking action to improve the voice call service of the subscriber based on a location where the subscriber negative voice call experiences occurred. In an embodiment, taking action comprises a customer care representative of the telecommunication company suggesting that the customer purchase a picocell device and install it in their residence based on the location where the subscriber negative voice call experiences occurred. In an embodiment, taking action comprises installing a different preferred roaming list (PRL) on a wireless communication device of the subscriber based on the location where the subscriber negative voice call experiences occurred.

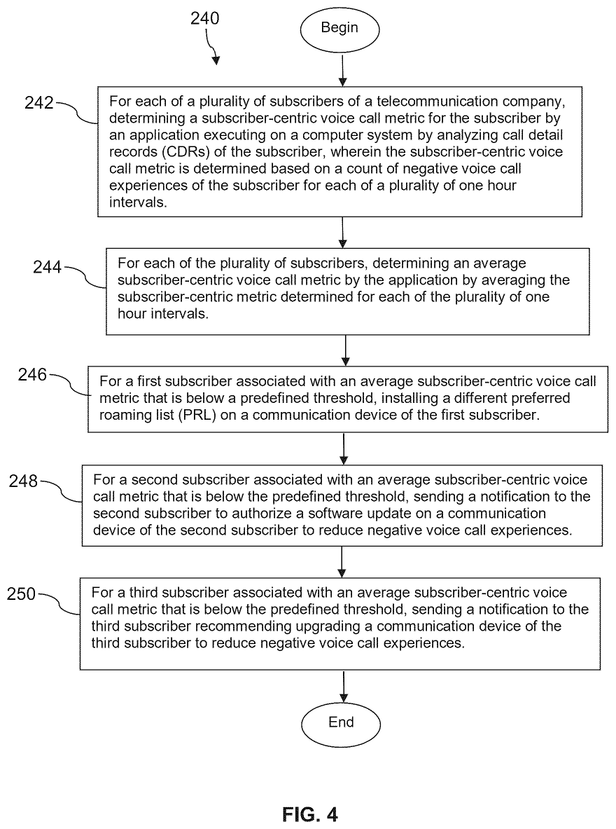

Turning now to FIG. 4, a method 240 is described. In an embodiment, the method 240 is a method of adapting a communication network to improve communication quality based on voice call metrics determined on a subscriber-by-subscriber basis. At block 242, the method 240 comprises, for each of a plurality of subscribers of a telecommunication company, determining a subscriber-centric voice call metric for the subscriber by an application executing on a computer system by analyzing call detail records (CDRs) of the subscriber, wherein the subscriber-centric voice call metric is determined based on a count of negative voice call experiences of the subscriber for each of a plurality of one hour intervals. In an embodiment, the negative voice call experiences comprise call drops. In an embodiment, the negative voice call experiences comprise call blocks. In an embodiment, the negative voice call experiences comprise calls having garbled voice content. In an embodiment, the negative voice call experiences comprise failed attempts to call to voice mail.

At block 244, the method 240 comprises, for each of the plurality of subscribers, determining an average subscriber-centric voice call metric by the application by averaging the subscriber-centric metric determined for each of the plurality of one hour intervals. At block 246, the method 240 comprises, for a first subscriber associated with an average subscriber-centric voice call metric that is below a predefined threshold, installing a different preferred roaming list (PRL) on a communication device of the first subscriber. In an embodiment, installing a different PRL on the communication device of the first subscriber is based on determining by the application a location of the first subscriber where at least some of a plurality of negative voice call experiences of the first subscriber occurred.

At block 248, the method 240 comprises, for a second subscriber associated with an average subscriber-centric voice call metric that is below the predefined threshold, sending a notification to the second subscriber to authorize a software update on a communication device of the second subscriber to reduce negative voice call experiences. At block 250, the method 240 comprises, for a third subscriber associated with an average subscriber-centric voice call metric that is below the predefined threshold, sending a notification to the third subscriber recommending upgrading a communication device of the third subscriber to reduce negative voice call experiences. In an embodiment, sending a notification to the third subscriber recommending upgrading the communication device of the third subscriber is based at least in part on the application determining the make and model of the communication device of the third subscriber.

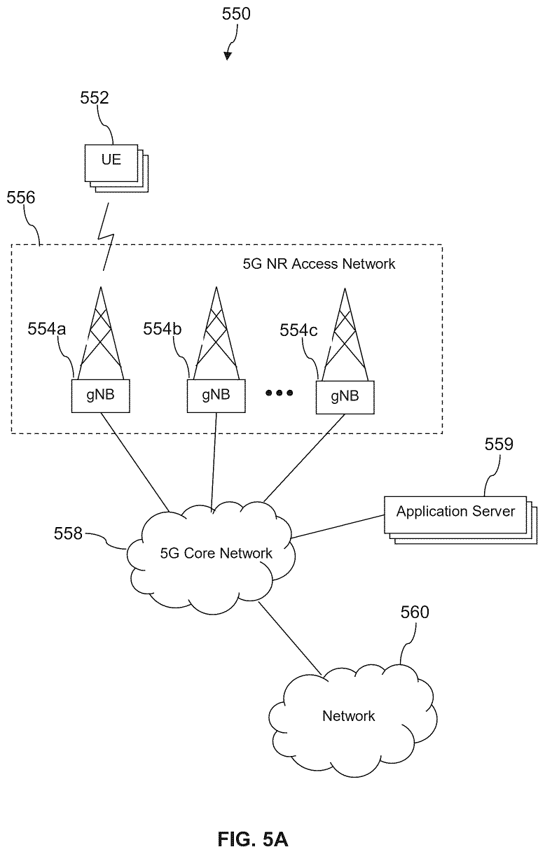

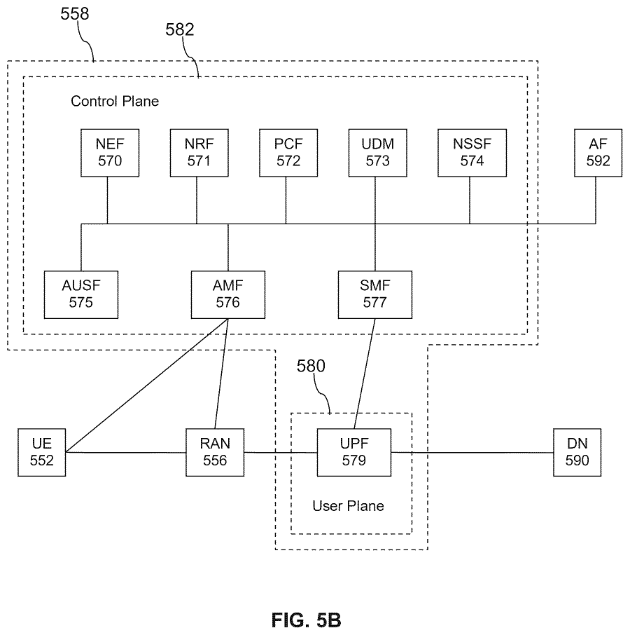

Turning now to FIG. 5A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHZ), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 5B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

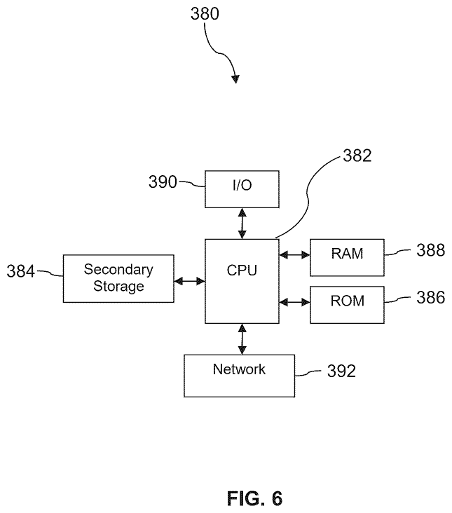

FIG. 6 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of adapting a communication network to improve communication quality based on voice call metrics determined on a subscriber-by-subscriber basis, comprising:
for each of a plurality of subscribers of a telecommunication company, determining a subscriber-centric voice call metric for the subscriber by an application executing on a computer system by analyzing call detail records (CDRs) of the subscriber, wherein the subscriber-centric voice call metric is determined based on a count of negative voice call experiences of the subscriber for each of a plurality of one hour intervals;
for each of the plurality of subscribers, determining an average subscriber-centric voice call metric by the application by averaging the subscriber-centric metric determined for each of the plurality of one hour intervals;
for a first subscriber associated with an average subscriber-centric voice call metric that is below a predefined threshold, installing a different preferred roaming list (PRL) on a communication device of the first subscriber;
for a second subscriber associated with an average subscriber-centric voice call metric that is below the predefined threshold, sending a notification to the second subscriber to authorize a software update on a communication device of the second subscriber to reduce negative voice call experiences; and
for a third subscriber associated with an average subscriber-centric voice call metric that is below the predefined threshold, sending a notification to the third subscriber recommending upgrading a communication device of the third subscriber to reduce negative voice call experiences.

2. The method of claim 1, wherein installing a different PRL on the communication device of the first subscriber is based on determining by the application a location of the first subscriber where at least some of a plurality of negative voice call experiences of the first subscriber occurred.

3. The method of claim 1, wherein sending a notification to the third subscriber recommending upgrading the communication device of the third subscriber is based at least in part on the application determining the make and model of the communication device of the third subscriber.

4. The method of claim 1, wherein the negative voice call experiences comprise call drops.

5. The method of claim 1, wherein the negative voice call experiences comprise call blocks.

6. The method of claim 1, wherein the negative voice call experiences comprise calls having garbled voice content.

7. A method of adapting a communication network to improve communication quality based on voice call metrics determined on a subscriber-by-subscriber basis, comprising:
for each of a plurality of subscribers of a telecommunication company, analyzing call detail records (CDRs) of the subscriber by an application executing on a computer system to identify negative voice call events;
for each negative voice call event, associating a location of a subscriber communication device at the time of the negative voice call event by the application to the negative voice call event;
for each of the plurality of subscribers, determining a subscriber-centric voice call metric for the subscriber by the application based on a count of negative voice call events of the subscriber for each of a plurality of one hour intervals;
for each of the plurality of subscribers, determining an average subscriber-centric voice call metric by the application by averaging the subscriber-centric metric values determined for each of the plurality of one hour intervals; and
for a subscriber associated with an average subscriber-centric voice call metric that is below a predefined threshold, taking action to improve the voice call service of the subscriber based on a location where the subscriber negative voice call experiences occurred.

8. The method of claim 7, wherein the average customer-centric voice call metric for each customer is determined over at least a one-week period of time and less than a two-week period of time.

9. The method of claim 7, wherein the average customer-centric voice call metric for each customer is determined over at least a two-week period of time and less than a three-month period of time.

10. The method of claim 7, wherein each subscriber communication device is a device selected from the group consisting of a mobile phone, a smart phone, a personal digital assistant (PDA), a wearable computer, a headset computer, a laptop computer, a notebook computer, and a tablet computer.

11. The method of claim 7, wherein taking action comprises a customer care representative of the telecommunication company suggesting that the customer purchase a picocell device and install it in their residence based on the location where the subscriber negative voice call experiences occurred.

12. The method of claim 7, wherein taking action comprises installing a different preferred roaming list (PRL) on a wireless communication device of the subscriber based on the location where the subscriber negative voice call experiences occurred.

13. The method of claim 7, wherein the communication network is one of a 6G, a 5G, or a long-term evolution communication network.

14. A method of adapting a communication network to improve communication quality based on voice call metrics determined on a subscriber-by-subscriber basis, comprising:
accessing subscriber voice call information from a first data store by an application executing on a computer system, where the call information is associated with a first period of time;
accessing subscriber churn information from a second data store by the application, where the subscriber churn information identifies subscribers of a telecommunication company who discontinue their telecommunication subscription service;
training a subscriber churn machine learning (ML) model based on the subscriber voice call information accessed from the first data store and based on the subscriber churn information accessed from the second data store by the application, wherein the subscriber churn ML model is configured to determine a risk of subscriber churn based on a subscriber-centric voice call metric;
for each of a plurality of subscribers of the telecommunication company, determining the subscriber-centric voice call metric for the subscriber by the application, wherein the subscriber-centric voice call metric is determined over a second period of time based on a count of dropped calls experienced by the subscriber, a count of blocked calls experienced by the subscriber, a count of garbled calls experienced by the subscriber, and a count of failed attempts to call a voice mail account of the subscriber, wherein the second period of time starts after the first period of time ends and wherein the second period of time is shorter than the first period of time;
for each of the plurality of subscribers, determining a risk of the subscriber churning by the application based on processing the subscriber-centric voice call metric of the subscriber determined over the second period of time using the subscriber churn ML model;
identifying a first subscriber associated with a risk of subscriber churn above a threshold; and
taking action to improve the voice call service of the first subscriber.

15. The method of claim 14, wherein the subscriber voice call information comprises an identity of a preferred roaming list (PRL) installed on a wireless communication device of the subscriber.

16. The method of claim 15, wherein taking action comprises installing a new PRL on a wireless communication device of the first subscriber.

17. The method of claim 14, wherein taking action comprises recommending that the first subscriber purchase a different wireless communication device.

18. The method of claim 14, wherein the communication network comprises a 5G communication network.

19. The method of claim 14, wherein the communication network comprises a long-term evolution (LTE) communication network.

20. The method of claim 14, wherein the subscriber voice call information comprises a device type of the subscriber.
